(19) United States
(12) Patent Application Publication
(10) Pub. No.: US 2013/0080690 A1
(43) Pub. Date: Mar. 28, 2013

(54) METHOD TO EMULATE EEPROM USING FLASH MEMORY

(71) Applicants: William Brooks Barrett, South Boston, MA (US); Lee R. Taylor, Boulder, CO (US)

(72) Inventors: William Brooks Barrett, South Boston, MA (US); Lee R. Taylor, Boulder, CO (US)

(21) Appl. No.: 13/616,974

(22) Filed: Sep. 14, 2012

Related U.S. Application Data
(60) Provisional application No. 61/538,376, filed on Sep. 23, 2011.

(51) Int. Cl. G06F 12/02

(52) U.S. Cl. 711/103; 711/E12.008

(57) ABSTRACT

Methods of using FLASH memory to emulate EEROM are disclosed. The present method uses two pages of FLASH memory, where each page is one or more separately erasable blocks. One page is referred to as the current page, while the other is the next page. Tokens, which are data structures containing a data element, are written in successive locations in the current page. When the current page is nearly completely filled, the write operation starts writing the new tokens to the next page. In some embodiments, to equalize the execution time of the write routine, the write routine also copies one token from the current page to the next page after a new token is written to the next page. Once all tokens have been copied to the next page, the current page can be erased. At this point, the next page becomes the current page.

This application claims priority of U.S. Provisional Patent Application Ser. No. 61/538,376, filed Sep. 23, 2011, the disclosure of which is incorporated herein by reference in its entirety.

### BACKGROUND OF THE INVENTION

Various technologies have been used to allow non-volatile storage of data to be modified. Magnetic storage, such as disk drives, allows this type of operation. However, in terms of access time and throughput, disk drives are much slower than semiconductor based solutions. EEPROM, or electrically erasable and programmable ROM, allows the user to write to a specific location in the device. This newly written data is now permanently retained by the device until rewritten. In other words, power cycling does not affect the contents of the device. EEPROM also has the added benefit that only one location needs to be modified at a time. There is no concept of block writes, where entire sections, or blocks, of memory need to be written at the same time. Thus, in this respect, EEPROM is the most similar to traditional RAM, while adding the benefit on non-volatility. However, EEPROM has several disadvantages that have slowed its development. First of all, the density of the devices is much less than other technologies. In other words, fewer bits can be manufactured in a given die size. This tends to increase the cost of the device, and limit its capacity in terms of total bit count.

FLASH memory has gained significant traction in the marketplace, due to its high capacity, low cost, and relatively simple programming model. FLASH, like EEPROM, is a rewritable non-volatile semiconductor based storage technology. FLASH memory must typically be erased and rewritten in blocks, rather than in individual bytes, like EEPROM. However, this is typically not an issue, as FLASH is commonly used to store program instructions, which are typically block written.

The biggest problem associated with FLASH occurs when it is used to emulate a non-volatile RAM device. That is, RAM allows an individual byte or word in the device to be modified without affecting any other data in the device. Due to the block erase limitations of FLASH, this type of individual data modification is difficult to perform. Another limitation is that each byte in a FLASH device can only be written a given number of times. Therefore, it is important to try to balance the number of write operations that are performed for each location within the FLASH. For example, assume that non-volatile data is stored in FLASH. Some of this data may be relatively constant, but other data may be highly variable. Assume that a range of locations, for example 10 locations, are used to store each variable, such that each new value is written in a new location. If one variable uses up all 10 of the locations that were assigned to it, the entire block needs to be erased before any new values for that variable can be stored again. At the same time, other variables may not have been altered at all, meaning that there were 9 memory locations associated with that variable that were never written before this erase was performed. Therefore, there is a technique known as “wear leveling”, which attempts to insure that all locations within a FLASH device are written approximately an equal number of times. However, these two limitations affect the effectiveness of these FLASH devices in applications where the FLASH is used to emulate a non-volatile RAM device.

Therefore, it would be beneficial if there were a method that allowed the individualized data modification required for these applications, while insuring that all locations of the device are “worn” equally. Furthermore, it would be advantageous if this method were appropriate in environments that require real time, or at least predictable, execution time.

### SUMMARY

The problems of the prior art are addressed by the methods of the present disclosure. The present method uses two pages of memory, where each page is one or more separately erasable blocks. One page is referred to as the current page, while the other is referred to as the next page. Tokens, which are data structures containing a data element, are written in successive locations in the current page. When the current page is nearly completely filled, the write operation starts writing the new tokens to the next page. In some embodiments, to insure that the execution time of the write routine is not unacceptably long while switching to the next page, the write routine also copies one token from the current page to the next page after a new token is written to the next page. Once all tokens have been copied to the next page, the current page can be erased. At this point, the next page becomes the current page and the current page becomes the next page.

### BRIEF DESCRIPTION OF THE DRAWINGS

FIG. 1 shows the overall memory architecture according to one embodiment;

FIG. 2 shows a memory having a plurality of tokens;

FIG. 3 shows how tokens are copied from one page to another according to one embodiment;

FIG. 4 shows the state of the memory after tokens have been copied, in accordance with the embodiment of FIG. 3;

FIG. 5 shows how tokens are populated according to another embodiment;

FIG. 6 shows additional tokens being written following the operation shown in FIG. 5;

FIG. 7 shows another token being written following the operation shown in FIG. 6;

FIG. 8 shows additional tokens being written following the operation shown in FIG. 7;

FIG. 9 shows the state of the memory after all tokens have been copied, in accordance with the embodiment of FIGS. 4-8;

FIG. 10 shows a flowchart of the write routine used in FIGS. 4-9;

FIG. 11 shows a variation of the flowchart of FIG. 10; and

FIG. 12 shows the state of the memory prior to a token being written.

### DETAILED DESCRIPTION OF THE INVENTION

As noted above, there are several limitations when using FLASH memory in applications where individualized data modification is required. There are some mechanisms that can be used to circumvent these limitations. As noted above, FLASH memory has a limitation that data must be erased in blocks, where a block may be, as an example, 512 bytes or more. Other block sizes are also within the scope of the invention. However, once erased, the data can be written to the block in units smaller than the block size, such as individual bytes or words. That is, the entire block does not need to be written concurrently. While this disclosure describes the use of FLASH as an example, it is understood that the methods equally apply to any block-oriented memory architecture.

This invention defines a method of organizing changeable non-volatile data in a FLASH memory, such that all bytes are equally worn, and each variable can be individually written and accessed. To do this, a software program product having two software routines may be used. The first is the write routine that implements the write strategy described herein. The second is the read routine, which finds the most recent version of each variable. The software program product and these routines are stored in a computer readable and executable media. These media include semiconductor memory, such as RAM, ROM, and DRAM, as well as magnetic and optical media. The software program product and these routines may be written in any suitable programming language. Furthermore, these routines may be separate programs, or may be integrated into a larger software program product. The specific implementation of these routines and the software program product is design specific and the implementation is not limited by the present disclosure. Furthermore, the methods described herein may be implemented in any computing device, including dedicated hardware or a special purpose processing unit.

The write routine is used to store data elements in the FLASH memory. Note that in traditional memory structures, such as RAM or EEPROM, a data element may be stored in a specific location, and changes to that data element are made by simply writing a new value to that location. Unfortunately, FLASH cannot be used in this manner. Once a location in FLASH memory has been written to a value, that value typically cannot be arbitrarily altered, unless the entire block of which this location is a part is erased. In other words, after a block of FLASH has been erased, each location in that block can typically be written to an arbitrary value only once.

Thus, one method of emulating EEPROM is to use at least two pages of FLASH memory as described below. A “page” as defined in this disclosure, is an integral number of separately erasable blocks. Thus, in some embodiments, a page may be made up of one block of FLASH memory. In other embodiments, the pages described below consist of multiple blocks. For example, if a single FLASH block is not large enough to hold all the data or all of the copies of data, the software may treat a group of several FLASH blocks as a single page.

These two pages must be separately erasable, such that the erasure of one page does not affect data written to the other page. In addition, although two pages are described herein, additional pages may also be used. These additional pages may be used to hold additional data, or may simply be used as spares. These spare pages may be used to replace faulty pages. For example, if the current page or next page fails such that a bit cannot be modified, the data from that page may be copied to one of the spare pages. That spare page then replaces the faulty page. The rest of the algorithm described above continues with this replacement page.

To begin, both pages are erased and one becomes designated as the current page while the other is designated as the next page. The current page, as the name suggests, is the memory page that is presently being used to store data, while the next page is the page that will be used when space in the current page is exhausted.

Rather than defining specific locations within the page as representing specific variables, as is typically done with EEPROM or RAM, a different approach is used. In this embodiment, each data element to be written to FLASH is bundled in an entity referred to as a token. A token may contain information, such as the identity of the data element being written and the length of the data element in bytes. Other fields may also be included in a data token. Thus, each token may contain the data element and its associated overhead information. In another embodiment, only the data element is stored. In other words, the term “token” is used to describe a particular data element and its associated overhead, if any exists.

An initial value for each data element is initialized and a token is then created and stored in the current page. Each data token may be located contiguously. In other words, the current page may be written as though it is a stack, where each token is written starting at the memory location following the last memory location used by the previous token. Thus, if one token is four bytes in length and is written into memory locations 53-56, the next token would be stored starting at memory location 57.

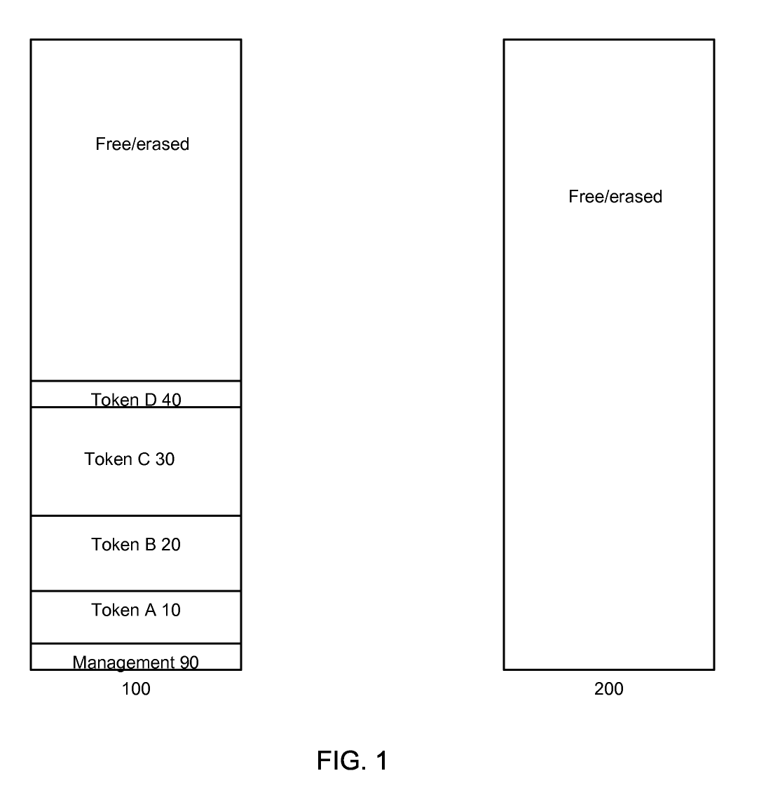

FIG. 1 shows one example. In this example, two pages are used, and a total of four different data tokens, known as A, B, C and D are stored. The first page 100 is initially designated as the current page, while the second page 200 is initially designated as the next page. The initial values of the data elements are stored as Token A 10, Token B 20, Token C 30 and Token D 40. Note that, in this example, the data elements and tokens are of different lengths, such that Token C is much bigger than those for Tokens A, B and D.

In addition to the storage of tokens, each page may also be written to include a management information section 90. This information may include data or attributes associated with the entire page, and the information stored in this section is an implementation decision. The invention is not limited by the size or content of the management information section 90.

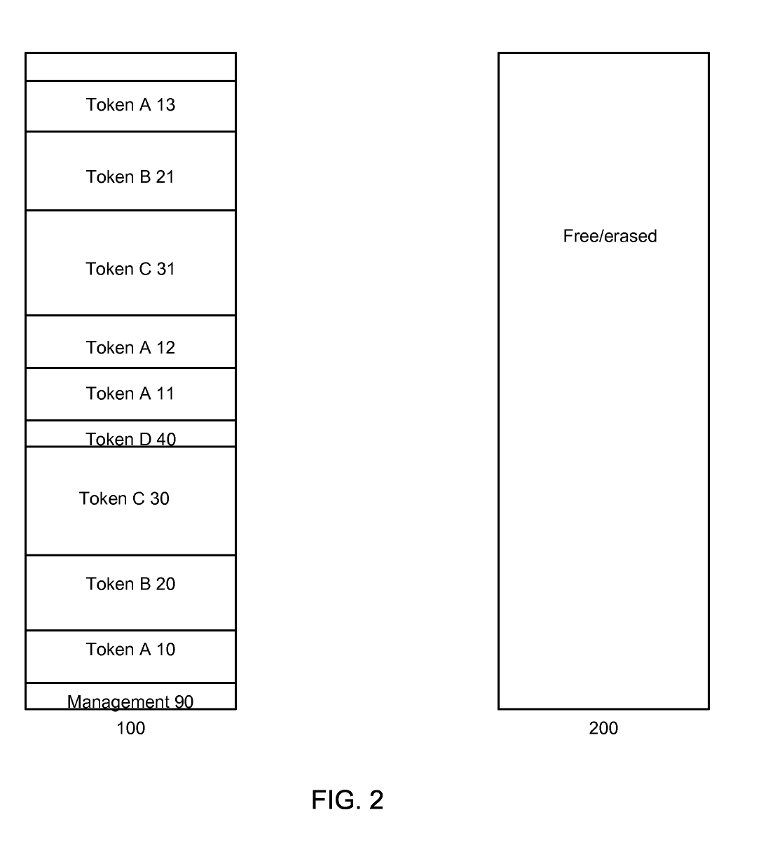

After the initial values of the data elements are written, the current page is used to store any changes that are made to data elements A, B, C, and D. These changes may happen in any order. For example, the data token A may be changed several times before data token D is ever modified. As such, the tokens that occupy the rest of the current page are in no specific order. In FIG. 2, data element A is written twice (as token 11 and token 12), followed by modifications to data elements C (as token 31) and B (token 21). Lastly, another modification is made to data element A (token 13). Note that data element D is never modified again in the current page. The present method has no restrictions on the frequency or order in which the data elements are written or modified.

The method used to write tokens utilizes the entire page, thereby insuring that all memory locations are equally used. This process continues until the current page 100 is filled. Once the entire page 100 has been filled, tokens are then written on the next page.

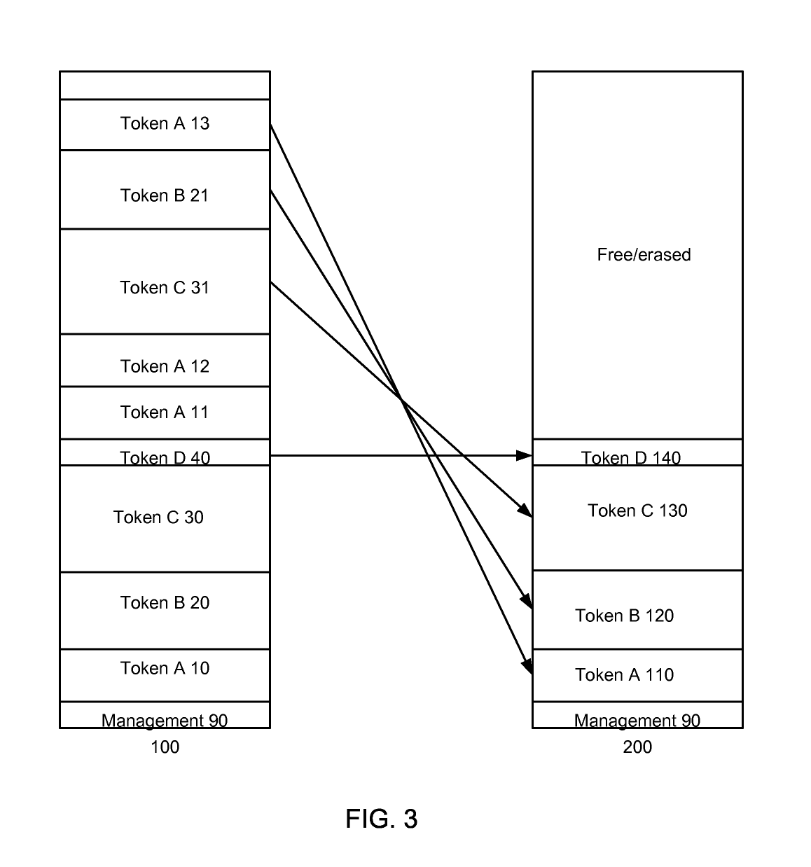

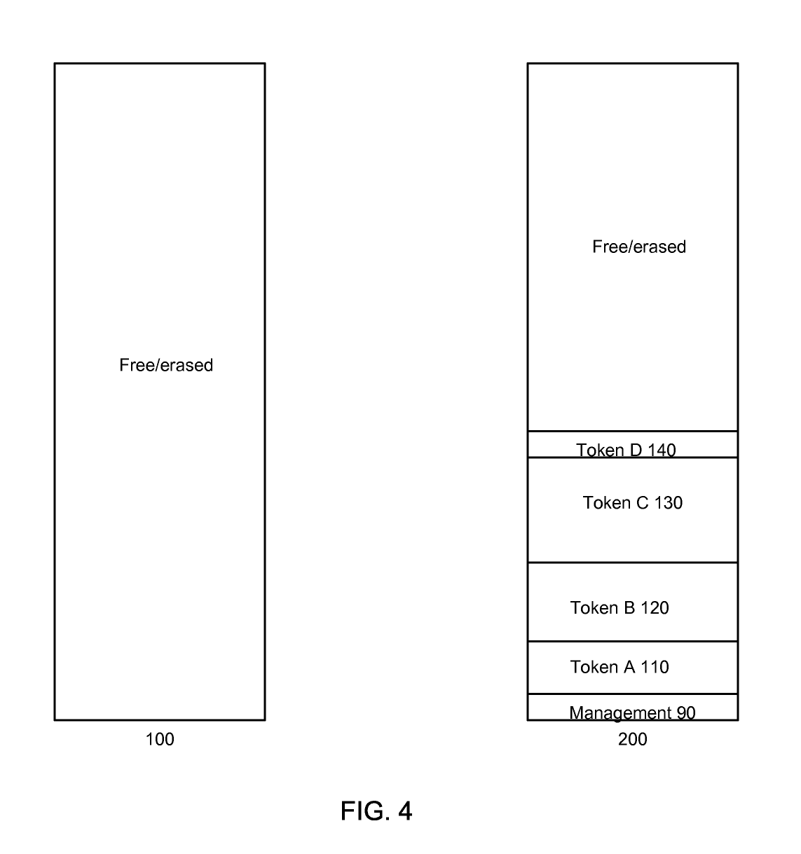

In one embodiment, shown in FIG. 3, when the current page 100 is filled, the most recent values of each data element are first written into the next page 200, as Token 110, Token 120, Token 130 and Token 140. In other words, Token 110 represents the most recent value of data element A, i.e. token 13. Similarly, Token 120 represents the most recent value of data element B (token 21); Token 130 represents the most recent value of data element C (token 31); and Token 140 represents the most recent value of data element D (token 40). Once these values are written to the next page 200, the next page 200 becomes designated as the current page. The previous current page 100 can now be erased and can then be designated as the next page, as shown in FIG. 4. The new current page 200 is now written as described above.

This write routine is an efficient method of updating the FLASH with new data. However, it is noted that when the last memory locations in the first page 100 are filled, the write routine must then copy the most recent version of each data element to the next page 200. In other words, in most instances, the write routine writes a particular data element to the FLASH and terminates operation. However, when the last memory location of a page has been filled, the write routine must recopy the most recent version of each data element to the next page 200. Depending on the number of data elements, this operation may be time consuming. This may be very problematic in cases where real time operation, or predictable execution times, is critical.

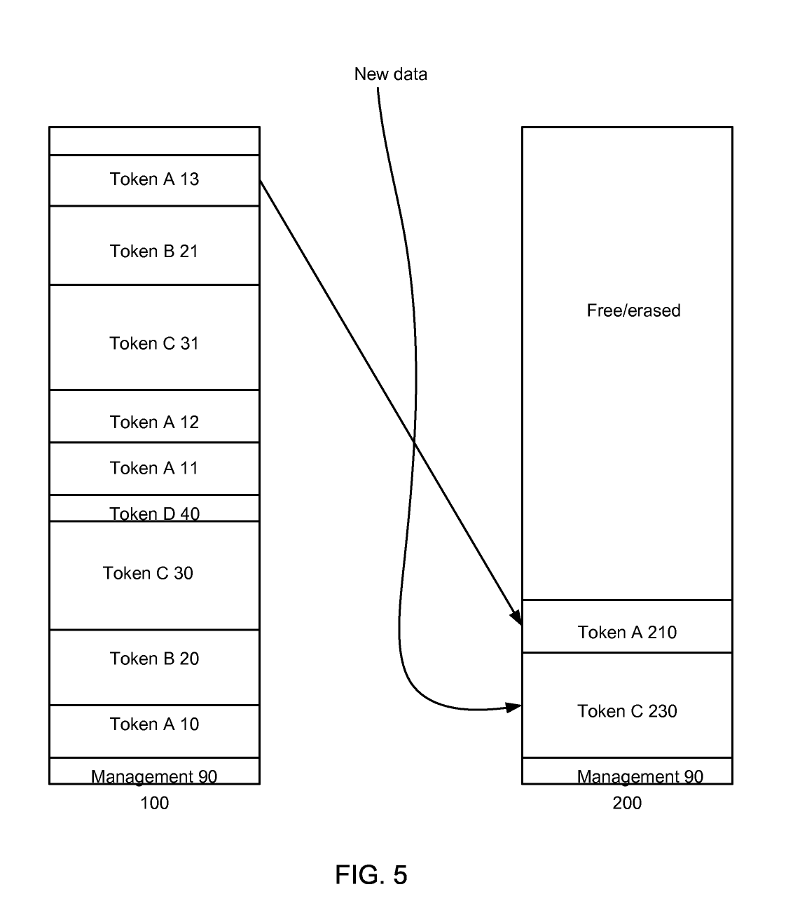

Therefore, in another embodiment, the write routine is modified to reduce this large discrepancy in execution time. Returning to FIG. 2, the current page 100 is nearly filled. The next token to be written is for Token C. However, there is not sufficient room to fit this token in the current page 100. Therefore, this token must be written to the next page 200, as Token C 230, as shown in FIG. 5. Rather than copying every token from current page 100 to next page 200, the new write routine only copies one token from current page 100, such as Token A 13 as Token A 210.

In some embodiments, the algorithm may copy a subset of the total number of tokens from the current page 100 to the next page 200. In other words, after Token C 230 is written to the next page 200, the algorithm may choose to copy several tokens from the current page 100 to the next page 200. In some embodiments, the choice of tokens and the number of tokens copied is determined based on total byte count. In one embodiment, tokens are selected such that an approximately equivalent number of bytes as the new token are copied. For example, if the new token is large, multiple smaller existing tokens may be copied until the same number of bytes has been copied. The number of tokens that are copied from the current page 100 to the next page 200 at this time is not limited by the present disclosure and may be any number less than the total number of tokens.

Note that the order in which the new Token (Token C 230) and the existing token (Token A 13) are written to the next page 200 is not limited by this disclosure, as either token may be written first.

In addition, the present description discloses that the order in which the tokens are copied from the current page 100 to the next page 200 is in accordance with their names (i.e. A, B, C, then D). However, other criteria can be used to decide the order in which tokens are copied from current page 100 to next page 200. For example, the algorithm may attempt to balance the total number of bytes being written. Thus, if the new token is large, the algorithm may seek a smaller token to be copied. Conversely, if the new token in relatively small in size, the algorithm may select a large token to copy.

In addition, when the next page 200 is first used, such as happens in FIG. 5, management information 90 must be written to it first. In some embodiments, this management data is written, and then the new token 230 and one saved token 210 are copied. In other embodiments, to reduce the duration of the write routine when a new page is started, only the management information 90 and the new token 230 are written.

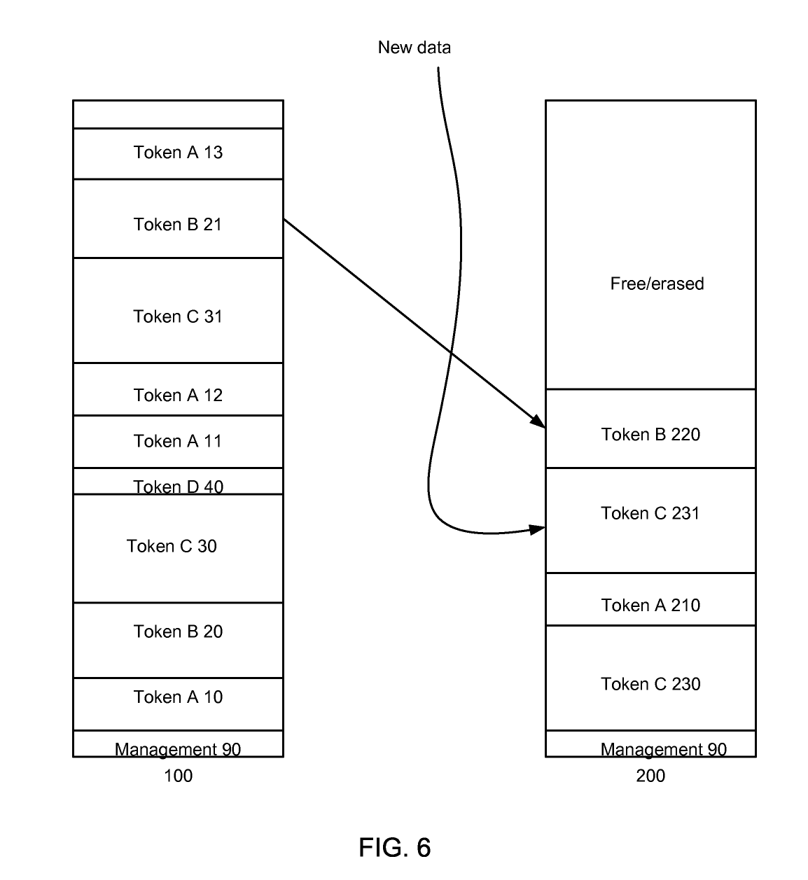

At a later time, a new token is generated, as shown in FIG. 6. In this case, it is again Token C, although it could be any other token as well. Since Token C does not fit in the current page 100, it is written to the next page 200. Additionally, a token (Token B 21) from the current page is also copied to the next page 200, as Token B 220. In other words, each time a new token is written to next page 200, one or more tokens, which has not yet been written to the next page 200, are copied as well.

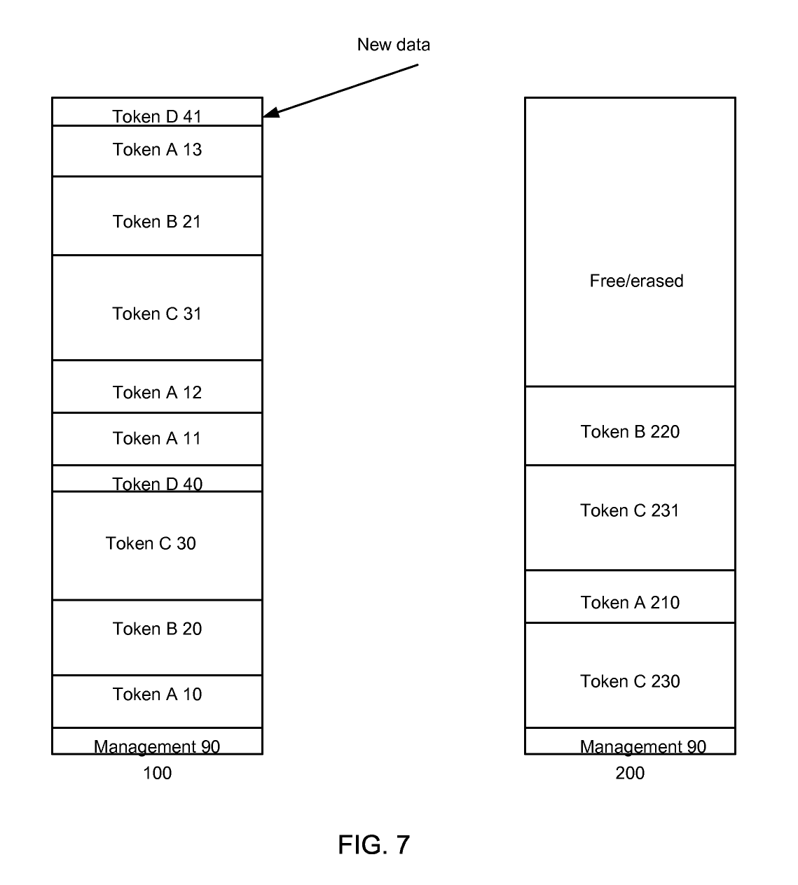

Assume for example, as shown in FIG. 7, that the next token to be written is Token D. Since Token D occupies less FLASH than Token C, it can fit in the current page 100. Therefore, Token D 41 is written to the current page 100 by the write routine. Since no accesses occurred to the next page 200, no tokens are copied over at this time. In some embodiments, the write operation checks whether the Token has already been rewritten to the next page. If it has, the token is also written to the next page, even if sufficient room exists to place it in the current page 100.

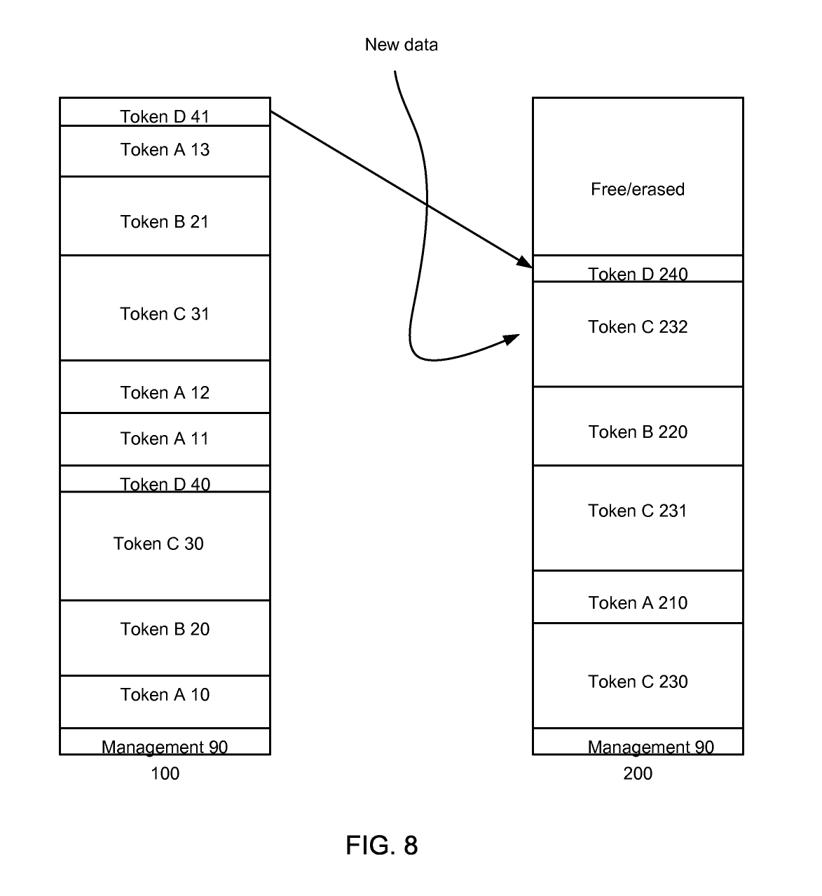

Next, as shown in FIG. 8, Token C is to be rewritten again. Since this token cannot fit on the current page 100, it must be written to the next page 200, as Token C 232. After the Token C 232, another stored token from the current page 100 is copied to the next page. Since Token A 210 and Token B 220 were previously copied, these do not have to be recopied. In addition, Token C has been written several times. Therefore, Token D 41 is the only remaining token from current page 100 that has not been copied to the next page 200. Once this token has been copied, there is no need to maintain any data on current page 100.

In some embodiments, the current page 100 is erased immediately after the last token is copied from the current page to the next page 200. In other words, the erase operation is initiated immediately after the last copy operation. In other embodiments, this page erase operation is performed during the next write operation to better equalize the execution time of the write routine. In other words, the current page 100 is not erased until another write operation is performed on the next page 200. In a third embodiment, the page is marked for erasure. The software may, at any time thereafter, detect that the page is marked for erasure and initiate this action. In other words, the erasure of the page does not need to be tied to the write operations.

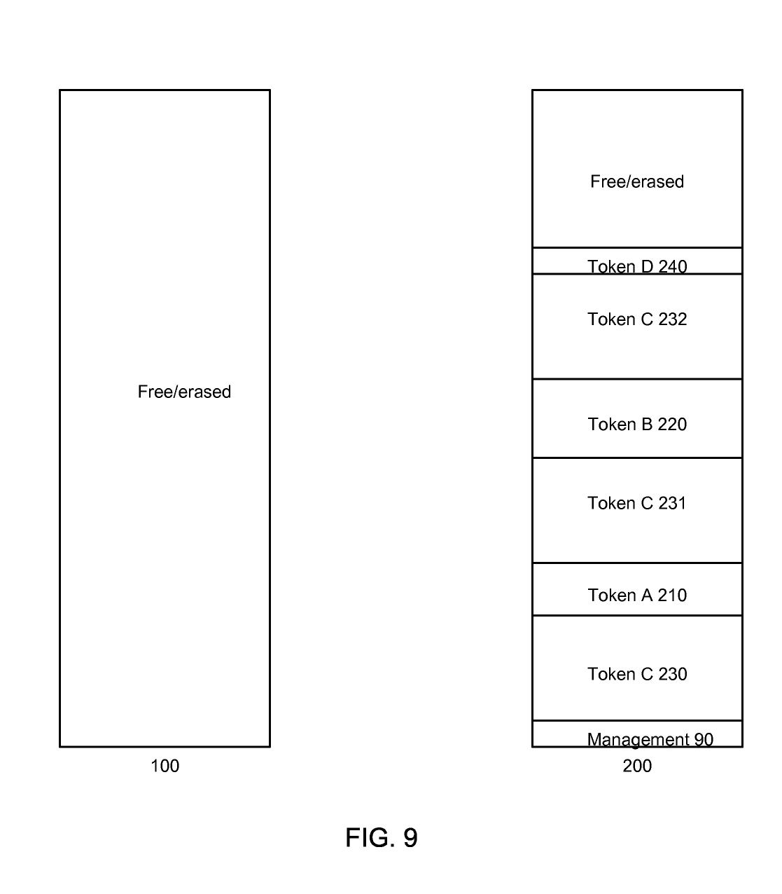

Thus, after Token D 240 has been written, the current page 100 is erased and the next page 200 becomes the current page, as shown in FIG. 9.

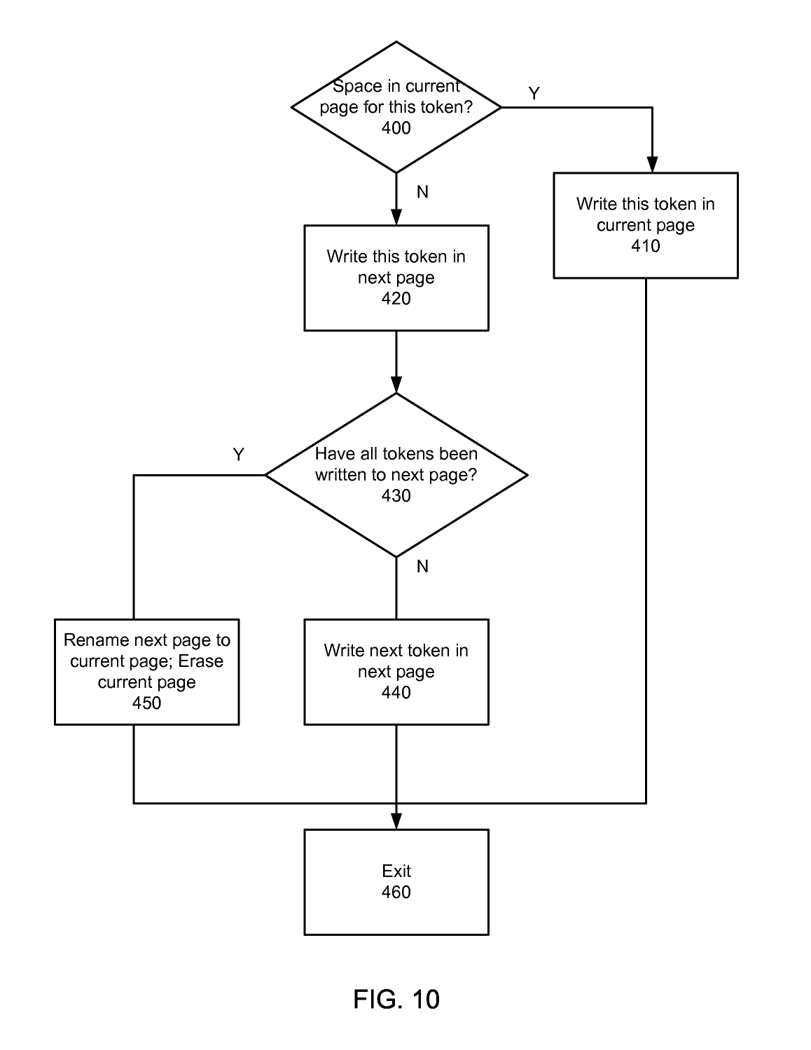

In summary, this method reduces the execution time of the write operation during the transition between the current page and the next page. The flowchart of FIG. 10 shows one embodiment of this write operation. When a new token needs to be written, the write routine first checks if there is space in the current page for this token, as shown in step 400.

If there is sufficient space, the token is written to the current page, as shown in step 410. At this point, the write routine terminates, as shown in step 460.

If there is not sufficient space, the token is written to the next page, as shown in step 420. The write routine then checks if an up-to-date copy of every token has been written to the next page. If not, the write routine copies one token that has not been written to next page, as shown in step 440.

If all of the tokens have been written to the next page, then the next page is renamed the current page and the former current page is erased.

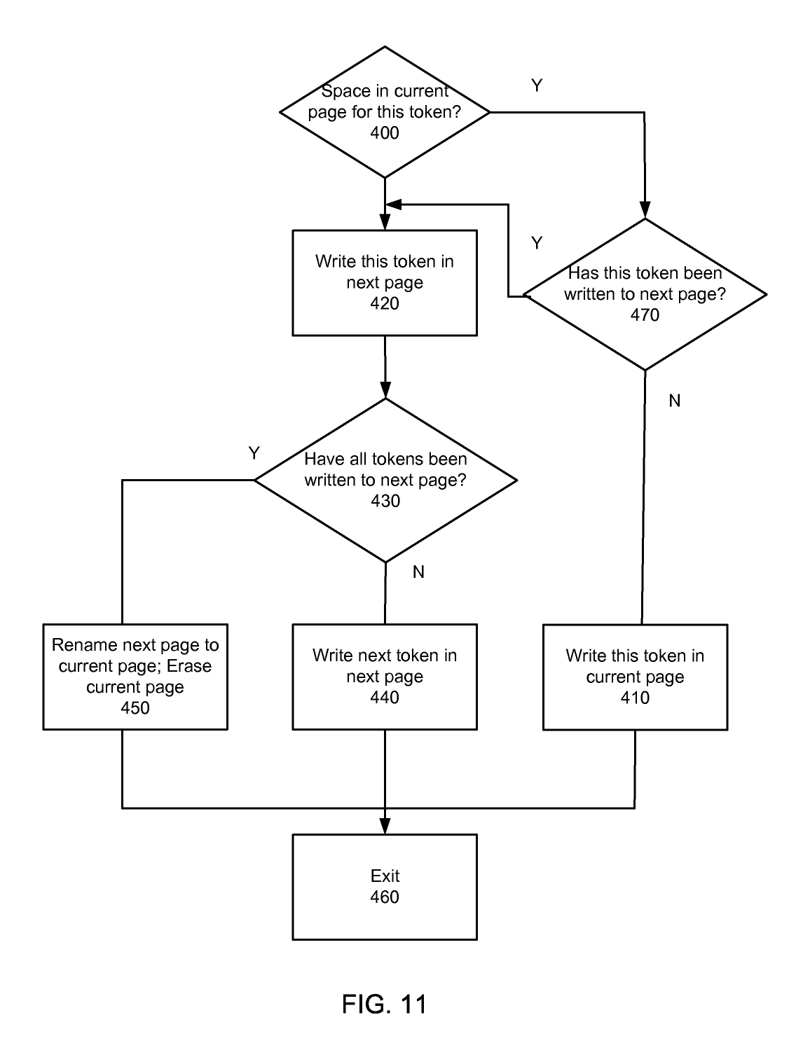

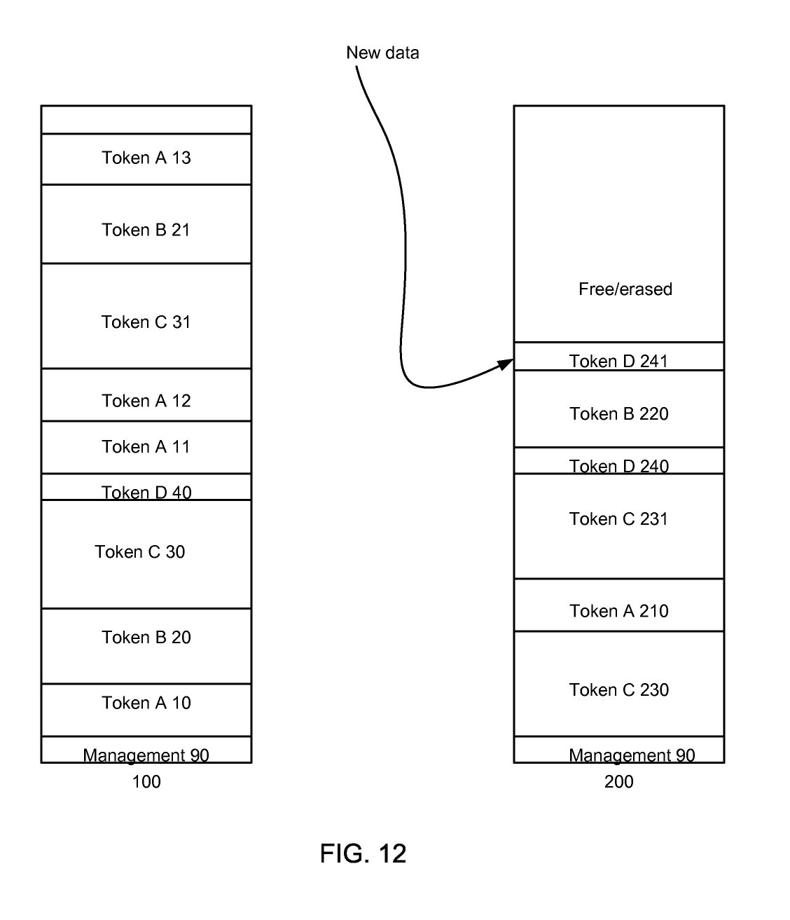

FIG. 11 shows a variation of the flowchart of FIG. 10. Referring to FIG. 12, assume that a new token D is to be written. As described earlier, this token can fit in the remaining space of current page 100. However, further assume that Token D has already been copied from the current page to the next page as Token D 240. In this scenario, if Token D is written into the current page 100, there will be a data coherence issue. This occurs because the newest value of Token D exists in the current page 100, but not the next page 200. Thus, in some embodiments, before a token is written to the current page, a check is performed to determine whether the most recent version of that token has already been copied to the next page 200, as shown in step 470. In this case, the token is written to the next page 200, and not written to the current page 100.

Thus, when sufficient space exists in the current page, a new data token is written to that page, and the write routine terminates. However, if there is insufficient space to store the new data token, the write routine performs two operations: it writes the new data token to the next page and also copies the most up-to-date version of a different data token from the current page to the next page. This write/copy step is performed until the most recent version of each data token has either been written or copied to the next page. Thus, if there are ten different data tokens, it may take up to nine separate write/copy operations until each of the data tokens exists in the next page. Once this occurs, the current page can be erased, and the next page becomes the current page.

The read operation is used to retrieve the most recent version of a particular data token. In some embodiments, the read operation determines the most recent version by reading from a table located in RAM. This table may contain the actual value of the data element, or a pointer to the memory location in FLASH memory where the most recent version of the data element is being stored. As this table is located in volatile RAM, it needs to be recreated each time the system is powered up. This technique has the advantage of being a very quick operation.

The initialization of the RAM table can be done in various ways. In one embodiment, this may be done by moving through the current page, starting at the bottom as shown in FIG. 2. The initialization routine begins at the bottom of the current page 100. It finds Token A 10. By reading the information contained in the token, such as the identity of the data element, the initialization routine is able to identity the data element and its value. This information is then stored in the volatile RAM table. As stated above, either the value of data element A, the memory location of the token, or both, is stored in RAM memory. The initialization routine then moves onto the next token. The starting address of the next token may be determined based on the length indicator contained in the current token. The memory address or value of Token B is then saved in the volatile RAM table. The initialization routine repeats this procedure for Token C 30 and Token D 40. It continues moving through the stack, reaching Token A 11. At this point, it updates the memory location or value for data element A previously stored in the RAM table based on Token A 11. Once the initialization routine operation has travelled the entire memory page 100, the RAM table contains the most recent version of each data element or the memory address of the most recent version of each data token. Therefore, from this point forward, the read operation simply references the RAM table to determine the current value or memory location of any data element.

To facilitate use of this RAM table, the write operation described above may be augmented to include a step of writing the address or value of each newly written data element directly to the RAM table.

There are variations of the write operation described above which may be performed. For example, in some embodiments, the information associated with the data element also contains a data integrity indicia. In one embodiment, this may be a checksum of the entire data token. In another embodiment, this may be an inversion of a portion or all or the data token. Of course, other data integrity indicia may also be used. This data integrity indicia protects against memory errors, and also protects against incompletely written data token. An incomplete data token may occur, for example, if power is interrupted while the write operation is writing a new data token to the FLASH memory.

Another variation allows more efficient use of certain data tokens. For example, some data tokens are used as counters, which increment (or decrement) by a fixed amount. Rather than creating a new data token each time the value is changed, the data token includes a field which indicates the number of times that the counter has been incremented. For example, a data token for a counter may include a field for an initial value and a field which indicates how many times the counter has been increments. In some embodiments, the value of the increment may also be stored if required. In some FLASH memory devices, it is possible to change a bit from a “1” to a “0”, but not to change from a “0” to a “1”. Thus, the field indicating the number of times that the counter has been incremented may be erased and set to “11111111”, indicating no increments have been performed. Each time the counter is incremented, one bit is changed to a “0”. This allows a one byte field to indicate up to 8 increments have occurred. This saves space and time over the alternate approach of creating a new token each time the counter is incremented.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. A method of using a block-oriented memory to emulate an electrically erasable memory (EEPROM), wherein said block-oriented memory is used to store a plurality of data tokens, wherein a data token comprises a data element and information about said data element, comprising:
using two pages, each erasable independently of the other, wherein one page is designated the current page and the second page is designated the next page;
writing a new data token to said current page if there is sufficient space in said current page to store said data token;
copying the most recent version of at least one of said plurality of data tokens from said current page to said next page and writing said new data token to said next page when sufficient space does not exist in said current page to store said new data token;
repeating said writing and copying step for each new data token until the most recent version of each of said plurality of data tokens has been written or copied to said next page;
erasing said current page when said repeating step is completed; and
designating said next page as current page.

2. The method of claim 1, wherein said tokens are written contiguously in said current page.

3. The method of claim 1, wherein said information about said token comprises an indication of the identity of the data element being written.

4. The method of claim 1, wherein said information about said token comprises an indication of the length of the data element.

5. The method of claim 1, wherein said most recent version at least one of said plurality of data tokens to be copied is selected based on the byte count of said most recent version.

6. The method of claim 5, wherein said most recent version at least one of said plurality of data tokens to be copied is selected based on the byte count of said new data token.

7. The method of claim 6, wherein said most recent version at least one of said plurality of data tokens to be copied is selected based on the total byte of said most recent version and said new data token.

8. The method of claim 1, further comprising writing management information to said next page when writing a first data token to said next page.

9. The method of claim 1, wherein said information about said data element comprises a data integrity indicia.

10. A method of using a block-oriented memory to emulate an electrically erasable memory (EEPROM), wherein said block-oriented memory is used to store a plurality of data tokens, wherein a data token comprises a data element and information about said data element, comprising:
using two pages, each erasable independently of the other, wherein one page is designated the current page and the second page is designated the next page;
writing a new data token to said current page if there is sufficient space in said current page to store said data token and a previous version of said data token has not already been written to said next page;
copying the most recent version of at least one of said plurality of data tokens from said current page to said next page and writing said new data token to said next page when sufficient space does not exist in said current page to store said new data token or when a previous version of said data token has already been written to said next page;
repeating said writing and copying step for each new data token until the most recent version of each of said plurality of data tokens has been written or copied to said next page;
erasing said current page when said repeating step is completed; and
designating said next page as current page.

11. The method of claim 10, wherein said tokens are written contiguously in said current page.

12. The method of claim 10, wherein said information about said token comprises an indication of the identity of the data element being written.

13. The method of claim 10, wherein said information about said token comprises an indication of the length of the data element.

14. The method of claim 10, wherein said most recent version at least one of said plurality of data tokens to be copied is selected based on the byte count of said most recent version.

15. The method of claim 14, wherein said most recent version at least one of said plurality of data tokens to be copied is selected based on the byte count of said new data token.

16. The method of claim 15, wherein said most recent version at least one of said plurality of data tokens to be copied is selected based on the total byte of said most recent version and said new data token.

17. The method of claim 10, further comprising writing management information to said next page when writing a first data token to said next page.

18. The method of claim 10, wherein said information about said data element comprises a data integrity indicia.

19. A software program product, comprising a non-transient storage media comprising a set of instructions adapted to be executed on a computing device, which, when executed, form a method of using a block-oriented memory to emulate an electrically erasable memory (EEPROM), wherein said block-oriented memory is used to store a plurality of data tokens, wherein a data token comprises a data element and information about said data element, comprising:
using two pages, each erasable independently of the other, wherein one page is designated the current page and the second page is designated the next page;
writing a new data token to said current page if there is sufficient space in said current page to store said data token and a previous version of said data token has not already been written to said next page;
copying the most recent version of at least one of said plurality of data tokens from said current page to said next page and writing said new data token to said next page when sufficient space does not exist in said current page to store said new data token or when a previous version of said data token has already been written to said next page;
repeating said writing and copying step for each new data token until the most recent version of each of said plurality of data tokens has been written or copied to said next page;
erasing said current page when said repeating step is completed; and
designating said next page as current page.
